(19) United States
(12) Patent Application Publication
(10) Pub. No.: US 2009/0248472 A1
(43) Pub. Date: Oct. 1, 2009

(54) DEALER CONTACT MANAGEMENT SOFTWARE AND SYSTEM

(75) Inventor: William M. Lloyd, Birmingham, MI (US)

Correspondence Address: BROOKS KUSHMAN P.C., 1000 TOWN CENTER, TWENTY-SECOND FLOOR, SOUTHFIELD, MI, 48075, US

(73) Assignee: SALEZTRACK LLC, Troy, MI (US)

(21) Appl. No.: 12/058,667

(22) Filed: Mar. 29, 2008

(51) Int. Cl. G06Q 10/00; G06Q 99/00

(52) U.S. Cl. 705/8; 705/7; 705/1

(57) ABSTRACT

A computer implemented method for monitoring a sales life cycle of a customer includes capturing primary customer information from a customer identification source (CIS), inputting secondary customer information, storing the information to generate a customer profile and automatically printing the customer profile. The method may also include communicating a message to the customer at a predetermined time before a scheduled follow-up appointment as a reminder about the scheduled appointment and displaying the customer's name on an electronic appointment board indicating the arrival status of the customer. A system implemented on a computer network is also presented which includes a first, second, and third device, a scanner, a printer, and an electronic appointment board. Also presented is a program with computer executable instructions embodied in a computer readable medium including instructions for performing the method.

### BACKGROUND OF THE INVENTION

1. Field of the Invention

The present invention relates to dealer contact management software and methods.

2. Background Art

The prior art has offered Dealership CRM solutions. Various examples of CRM software solutions and providers are known in the art including Automotive Business Solutions (www.automotivebusinesssolutions.com), ProResponse (www.proresponse.com), and Prospector offered by the Cobalt Group (www.cobalt.com).

### SUMMARY OF THE INVENTION

A dealer contact management software and systems provides for effective and efficient customer traffic and sales tracking and may be particularly suited for use in an automobile dealership. The dealer contact management software and systems may be housed in a kiosk. When a prospective customer visits a retail store, the sales personnel may scan a prospective customer's drivers license and generate a record in the store's customer database. Upon scanning, inputting, and storing the customer information, a “guest” sheet may be automatically printed to serve as a sales document. Printing the document is not an option for the sales personnel; once the record is complete and stored, the document is automatically printed by the system. Once the prospect has been scanned and entered, the customer's sales life cycle may then be tracked through a business development center (BDC) component of the system software. Through their daily work plan generated by the BDC, employees may follow-up on unsold prospects or remind existing customers of their upcoming service requests. A showroom appointment board that works in conjunction with the BDC may provide a visual reminder to the sales personnel of their upcoming appointment and a welcome message for the customer. This visual display may create a positive impact for the store. The appointment board may implement a color scheme which shows the sales personnel which appointments have yet to be follow-up on, which have confirmed, and which have arrived.

These and other features, aspects, and advantages of the present invention will become better understood with regard to the following description, appended claims, and accompanying drawings.

### BRIEF DESCRIPTION OF THE DRAWINGS

FIG. 1 shows an exemplary embodiment of the operating environment for implementation of various exemplary embodiments of the invention.

FIG. 2 shows a flow diagram illustrating the steps in one exemplary embodiment of the dealer contact management software and system.

FIG. 3 shows a flow diagram illustrating the steps in another exemplary embodiment of the dealer contact management software and system.

### DETAILED DESCRIPTION

An automotive dealer contact management software and systems is presented. The automotive dealer contact management software and system provides for effective and efficient customer traffic and sales tracking. While the embodiments of this invention are described in the context of an auto dealership, they are not limited to this environment. Users in other areas of sales-related businesses can benefit from the disclosed embodiments.

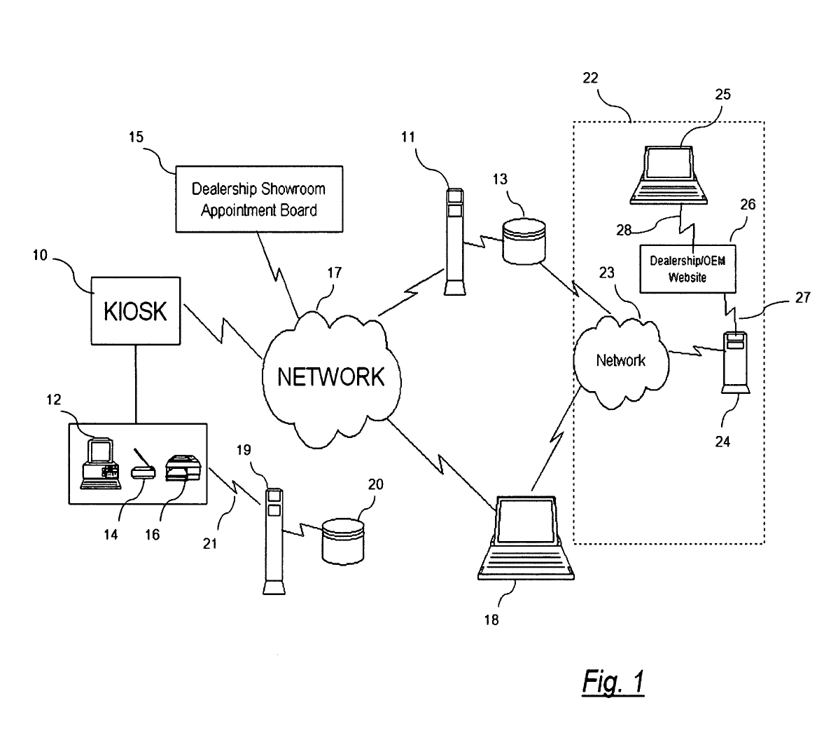

FIG. 1 shows an exemplary embodiment of the operating environment for implementation of the various embodiments of the automotive dealer contact management system. The system may be comprised of a front end component and a back end component. The system may also require a network 17 for its operation and communication between the front end and back end components. The front end system may be housed in a kiosk 10. It is contemplated that the kiosk 10 may be visible to customers and dealership employees and located in the dealership showroom. The design and shape of the kiosk 10 is not limited to a particular embodiment. It is contemplated that the kiosk 10 can be designed so that the hardware of the system can be feasibly connected in one housing. The hardware components of the system may include a terminal 12, a digital drivers license scanner 14, and a printer 16.

In the back end of the system may be one or more terminals 18 used by the dealership sales personnel for managing their customer docket and following-up with current and prospective customers. Communicating through network 17 with the at least one terminal 18 may be a customer database 13 contained within a dealership server 11 for storing customer information. In one embodiment, customer docket management and follow-up may be accomplished through terminal 12 without the need for separate terminals 18 such that the operation of the front and back end components of the system may be accomplished through the terminal 12 in communication with server 11.

The terminal 12 of the front end system, contained in the kiosk 10, can be, but is not limited to, a desktop computer, laptop computer, or any other PC device. The terminal 12 may be used by dealership personnel to view and input a customer's information from a CIS. The driver's license scanner 14 may be connected to the terminal 12 via a cable connection, including, but not limited to, USB or a serial cable, or via wireless technology including, but not limited to, infrared or WiFi. The digital scanner 14 may be used for automatically scanning customer information from the customer identification source (“CIS”) and storing the scanned information into the customer database 13 through network 17 thereby automating the process of entering customer credentials and minimizing manual input. The CIS can include, but is not limited to, customer driver's licenses or business cards. The contemplated embodiment of the scanner 14 includes a camera which captures full images and text of a CIS. Once captured, the image and text are exported to the customer database 13 for storage and retrieval. In one embodiment, the export occurs through network 17. The communication between the kiosk 10 and the server 11 and database 13 may be wired or wireless. In another embodiment, the scanner 14 automatically populates the fields of the database 13 with the customer information using optical character recognition (OCR) technology. The scanner 14 may also include authentication software for detecting fraudulent driver's licenses. One scanner 14 that may be used for practicing the invention is the Snapshell Fda™, although other scanners known in the art can also be used.

Also in communication with the terminal 12 and the dealership server 11 may be a printer 16. The printer 16 may be connected to the terminal 12 via a cable connection, including, but not limited to, USB or a serial cable, or via wireless technology including, but not limited to, infrared or WiFi. In one embodiment, the printer may communicate with server 11 through network 17. Communication between the printer 16 and the server 17 may be wired or wireless. The printer 16 is used for printing customer tracking sheets automatically upon scanning in a prospective customer's information from the CIS and storing the customer information into the customer database 13. The operation of automatically generating the tracking sheet will be described in further detail below. The printer 16 can be any inkjet or laserjet printer known in the art.

As stated above, the front end system communicates with the back-end system of the dealer contact management system through network 17. Network 17 may be wired or wireless. The back-end system includes at least one user terminal 18 and at least one server 11, 19. The at least one user terminal 18 can be, but is not limited to, a desktop computer, laptop computer, or any other PC device. The dealership server 11 in communication with at least one terminal 18 at the back-end, may house the software for executing the automotive dealer contact management system and may include a database 13 for storing, retrieving, and following up on customer profile information. In one embodiment, the software and database 13 is external to the server 11 and communicates with server 11 through connection 22. Connection 22 can be any wired or wireless connection capable of connecting server 11 to database 13. The server 11 may also be in communication with kiosk 10. For example, once a CIS has been scanned and stored into database 13, the server 11 may transmit a signal to the printer 16 for automatically printing customer sales sheets. In one embodiment, the communication may occur through network 17. The contemplated embodiment of the database 13 is a SQL server database, however, any other relational database known in the art can be used.

The contact management software may be a GUI based program that incorporates a user friendly interface. The software may be housed in the dealership in at least one terminal 18 and may be customizable to each dealership. In one embodiment, the software may be housed in server 11, and accessed from a user terminal, or housed in terminal 12. The software contains computer executable instructions for operating the automotive contact management system. For example, it may contain instructions for receiving the scanned information from the CIS, pushing the obtained information to the server 11, and using the information to populate the fields of prospective customer records within the customer database 13.

In one embodiment, the software may also be in communication with system 22. System 22 may be comprised of a server of a third party application service provider 24 (“ASP”) which may receive visitor data from a Dealership website visitor 25 through Dealership/OEM website 26. Communication between website visitor 25 and the Dealership/OEM website may occur through connection 28 and communication between Dealership/OEM website and ASP server 24 may occur through connection 27. Connection 27 and connection 28 may be any network connection capable of sending information between the Dealership/OEM website 26 and the website visitor 25 and the Website 26 and ASP server 24 including, but not limited to, the Internet. As will be further described below, visitor information received from ASP server 24 and transmitted to Dealership server 11 and accessible by sales personnel through at least one user terminal 18 may be accomplished through network connection 23. Network connection 22 may be any connection capable of networking at least one terminal 18 to server 22 including, but not limited to, the Internet.

The ASP server 24 may contain applications that may be developed by the ASP to, for example, receive in-bound Internet leads that are sent to the Dealership for lead generation and follow-up by the sales personnel, to generate e-mail, voice broadcasted, and text based messages to send to prospective and current customers automatically or manually, and to track a customer's service schedule to generate service appointment reminders automatically or manually. Other applications may be added for the convenience of the user. One of ordinary skill in the art will know and understand how to implement the use of an ASP server.

Also incorporated may be an appointment board 15 for displaying pending and arrived appointments to showroom customers and sales personnel. The operation of the appointment board will be discussed below in detail. The appointment board 15 is a display that may be in communication with the front-end and/or back-end systems. In one embodiment, the appointment board 15 can be an LCD display in communication with the server 11 through the auto dealer's network 17. The LCD display can be of any size although it is contemplated that it be of a size that is visible to customers and sales personnel on the showroom floor. The appointment board 15 may be managed through an appointment board application.

In one embodiment, the back end server 11 may host the appointment board application. In an alternative embodiment, the application may be developed by the ASP and hosted at ASP server 24. Some non-limiting examples of the function of the appointment board application include, but are not limited to, appointment management for sales personnel, status checking of appointment confirmations, and the generation of productivity and efficiency reports regarding the sale personnel's follow-up track record. The appointment board 15 may be also in communication with a business development center (BDC) component of the system software. The BDC component will be further described in detail below.

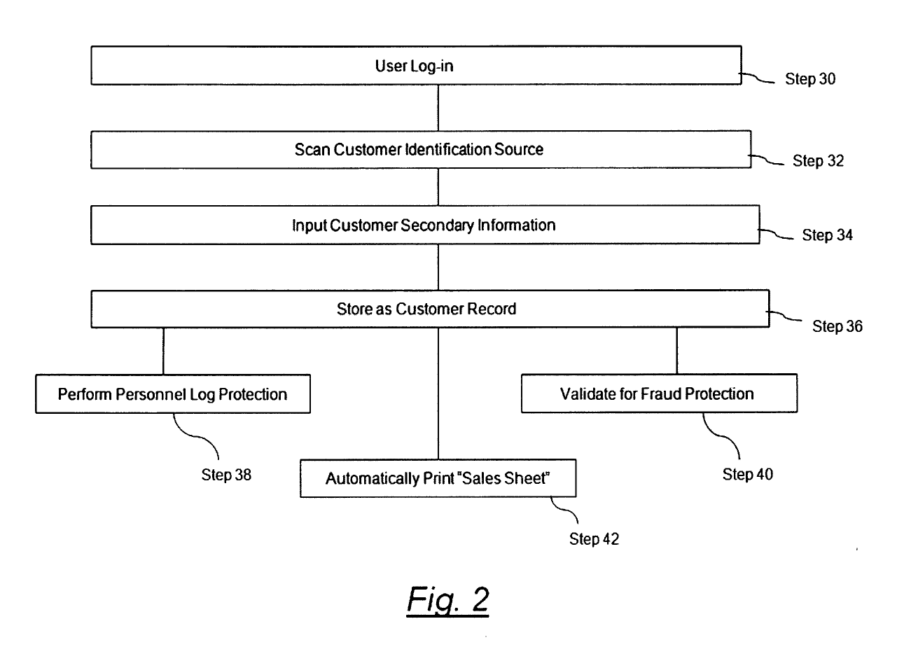

The operation of the automotive dealer contact management system is best illustrated through an example with reference to FIG. 2. Non-limiting examples of means through which customer leads may be generated include prospective customers physically visiting a dealership store, inbound emails and phone calls expressing interests in a vehicle, or Internet leads from customers surfing the web and “virtually” visiting a dealership.

When a prospective customer physically visits an auto dealership, the dealership sales personnel may take the prospective customer's drivers license and place it in the driver's license scanner 14 housed in the kiosk 10 and in communication with terminal 12. Generally, the prospective customer will be interested in test driving a new or used car. As previously mentioned, while the invention contemplates the use of a driver's license, other forms of client identification sources can be used such as business cards. The sales personnel may log into the system step 30 prior to accessing the terminal 12 and scanner 14. The user may log in step 30 by entering their username and password or through fingerprint recognition.

The personnel will scan the customer's CIS step 32 in order to populate the customer database 13 with information retrieved from the CIS and create a record of the customer. In one embodiment, the retrieved information may include, but is not limited to, a customer name, address, birth date, and a JPEG of the customer's driver license picture. The sales personnel may scan both the front and back ends of the prospective customer's license. Furthermore, if a co-buyer is present with the customer, then the co-buyer's driver's license, or other CIS, may also be scanned and the information populated into the database 13. In one embodiment, the primary customer and secondary customer information are contained within one record. Upon scanning the CIS, the user may be given an opportunity to enter secondary information step 32 pertaining to the customer. For example, any information the scanner 14 was unable to read or populate from the client identification source may be inputted manually by the sales personnel step 32. Non-limiting examples of such secondary information can include advertising information, whether the customer is trading in a car, whether they are buying new or used, the customer's e-mail information or any additional comments.

Once the information has been scanned and/or inputted by the sales personnel through terminal 12, the information is automatically populated into the appropriate fields of the auto dealership's customer database 13, step 36. While the information is being populated into the database 13, other non-limiting functions may also be performed such as validating the buyer and co-buyer's information step 40 against TransUnion's fraud prevention and OFAC list, determining if the prospect has already been logged step 38 (as will be described below), and automating a drivers license check, as required by some states, to prevent sales to prospects that will be denied titling.

With reference again to FIG. 1, the fraud check step 40 may occur through an external server 19 and database 20, communicating through connection 21. Database 20 may be housed within external server 19. Connection 21 may be any wired or wireless connection. Furthermore, Connection 21 may be an external network such as the Internet. The fraud detection database 20 may contain records of individuals with a history of fraudulent activity. This scanning process creates at least one advantage for the dealership in that it eliminates tedious manual entry of primary customer information, thereby creating efficiency in accounting for customer traffic.

In one embodiment, upon scanning step 32 and inputting step 34 all of the customer's information, the prospective customer profile may be transmitted to the dealership server 11 from the terminal 12 and stored to the customer database 13. Once transmitted and stored, a return signal is sent from the server 11 to the printer 16. The signal may cause a customer tracking sales sheet to be automatically generated step 42. It is contemplated that the communication may occur through the network 17. That is, without manual commands, the printer 16 is automatically signaled to print a customer sales sheet step 42 once all the information on the prospective customer has been inputted at the kiosk terminal 12 and exported to the database 13. In this way, the document serves multiple purposes: (1) it serves as a means for a dealer to work a proposal or quote, (2) it automatically creates a physical record for the dealership which is useful in situations when the electronic records is nonfunctional, and (3) it serves as a means for the dealership to physically track a customer for follow-up marketing by collecting showroom traffic. In one embodiment, the sale personnel may be prompted as to whether a used car appraisal form is required. This may be beneficial for situations where the buyer is trading in a vehicle.

Accordingly, the required and automatically printed sales sheet generates a system of accountability for each sales employee in that a physical and electronic record serves to associate a sales personnel with at least one prospective customer. Therefore, the sales personnel's marketing efforts may be tracked. Furthermore, prospects feel appreciated and in turn appreciate the dealership's professionalism. Prospects know they are not “just another customer” and that their business matters. As such, following-up with each prospect will maximize a business entity's bottom line revenue. For example, in the auto dealership industry, it has been determined that 52% of prospects buy within 72 hours of their first visit while 90% buy within 90 days without some follow-up. Through the accountability and follow-up the automatically generated sales sheet offers, a dealership's ability to close on a prospect increases because of the psychological pressure proper follow-up places on a prospect. Other features of the embodiments presented will also provide similar benefits as will be described in further detail below.

The customer sales sheet may be customized to the auto dealership. It may include pertinent information relating to the customer and the dealership that would provide for easy and informed follow up by the dealership sales personnel. The information may include any information that a dealer uses to work a proposal or quote and identify information on the prospective customer. In some embodiments, the information may also include a used car appraisal form used when a prospect is trading in a vehicle. While this is the information contemplated in practicing the invention, it is not limited to such information.

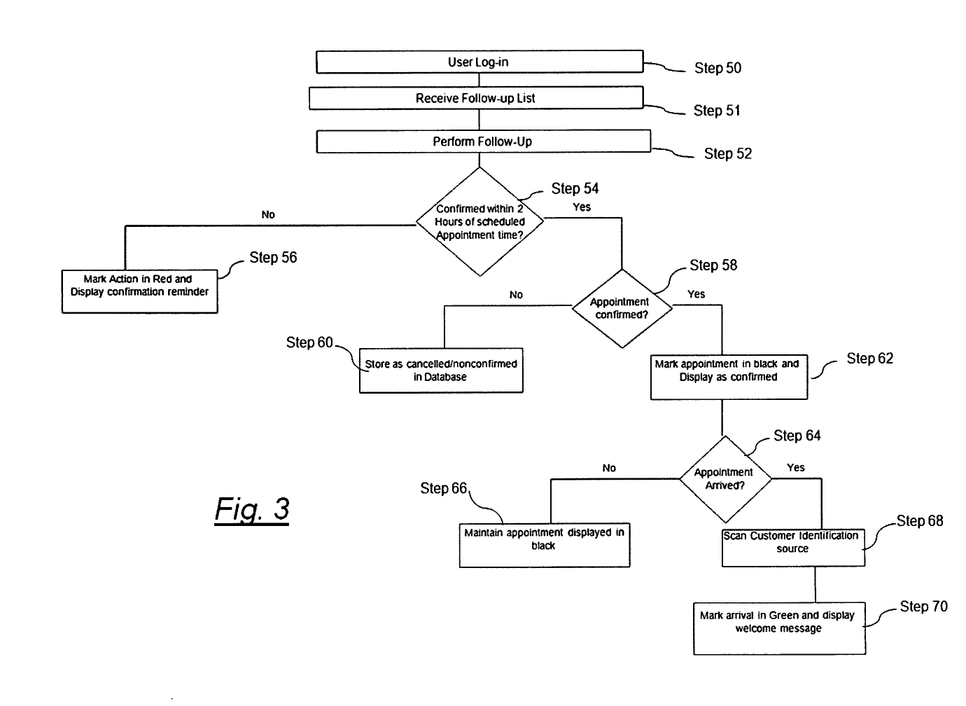

With respect to FIGS. 2 and 3, once the prospect has been scanned and entered step 36, a customer's sales life cycle is tracked through a business development center (BDC) component of the software. The BDC communicates with the customer database 13 to track the sales activities of an existing and prospective customer such as when he or she was first inputted into the system, their visits, their purchases including their last purchase made, and their vehicle service schedule. Furthermore, the BDC allows the employees to identify completed calls, appointments, logged prospects, and sold customers.

In operation of the BDC, sales personnel may log into the automotive dealer contact management system from their user terminal step 50. In one embodiment, the sales personnel may also log in to the BDC remotely. Every sales personnel may receive an electronic daily marketing work plan to manage their follow-up activity step 51. In one embodiment, the daily work plan may be an online calendar, organized by day of the week, indicating to the sales personnel which contacts need follow-up for that day. Once the sales personnel has logged in and retrieved their daily work plan, they may initiate their follow-ups for that day through telephone or e-mail step 52. In one embodiment, the sales personnel may follow-up on unsold prospects based on the system's tracking of which prospects, based on the prospect's initial visit to the dealership, failed to purchase a vehicle.

In another embodiment, the system may also provide follow-up capabilities on the vehicle servicing side for an existing customer. For example, after a vehicle has been purchased, the BDC tracks the customer's service schedule based on purchase date, last servicing or mileage and automatically sends a follow-up on the existing customer for their next servicing appointment. The personnel through the BDC may follow-up through automated voice broadcasted and email broadcasted maintenance reminders. In one embodiment, the e-mail maintenance reminders are broadcasted through whitelisted servers. Thus, using the entered data from the initial customer contact, whether through an in-person visit, e-mail or phone call, dealerships can create follow-ups through focused telemarketing initiatives, direct mail campaigns, and other types of focused marketing initiatives on existing and prospective customers. For managers, the BDC benefits them because they can gauge the success of a marketing campaign through reports detailing the results of the campaign.

Also provided in the BDC component may be a log protection for sales personnel. For example, if a non-purchasing repeat customer visits the same dealership and had already been logged after his or her first visit, the second sales personnel will be notified through their user terminal, after scanning the prospect's drivers license, that the prospect is already entered into the system. In one embodiment, this verification may be performed through a cross-check in the customer database. The notification may be through a pop-up window. Once the system identifies the sales personnel that originally logged the prospect, he or she may receive a percentage of the commission where the second sales personnel closes on a deal with the prospect. Thus, a further incentive is provided to the dealership and sales personnel to keep track of their marketing efforts.

A dealership may also implement a showroom appointment board. The BDC suite can inform sales personnel of pending and confirmed appointments, track the user's daily follow-up tasks, display whether a contact is pending or confirmed, and detail which prospects are unsold within a date range. These non-limiting benefits may be realized through various algorithms programmed into the software and communicating with the BDC component.

Once a follow-up is made by the personnel step 52, and if the appointment is confirmed, the BDC suite may link the information to the appointment board. In one embodiment, the appointment board may display pending and completed appointments for the day and provide an indicator of whether the appointment has arrived step 64. Furthermore, any and all appointments must be confirmed within a specific time frame within the customer's arrival step 54. For example, the appointment must be confirmed within two hours of the customer's arrival. If the sales personnel has been tardy in confirming the appointment within the predetermined time frame, the appointment board application may mark the action in a specific color such as red and display a reminder message to the personnel to perform a proper follow-up step 56.

If the personnel has confirmed the appointment on time, using a specific color scheme, the appointment board application may allow dealership employees to determine which appointments have arrived and which are pending step 64. For example, those appointments which still require confirmation may be displayed in red and indicate to the employee that the prospects appointment needs to be confirmed step 56. A message may also be displayed to the employee that the appointment needs to be confirmed. Once the appointment has been confirmed, the prospect may be displayed in black with a message that a confirmation has been made step 62. Finally, if the appointment arrives at the dealership, the name may turn green and a message displayed stating that the appointment has arrived step 68. In one embodiment, the message also welcomes the customer. If the appointment has not arrived, the customer's name may not change color step 66. As stated above, these features may be realized through the appointment board application containing computer executable algorithms and instructions for performing these functions.

At least one benefit of the appointment board 15 is the increase in the appointment closing ratio, i.e., the ratio of appointments made to deal closings. For example, in some instances, there has been an increase in the ratio equal to 60%. The appointment board 15 also promotes best practice standards for the employees through positive visual feedback. For example, an employee can see which of their appointments have confirmed their arrival, creating a visual feedback of their follow-up efforts. Additionally, the appointment board 15 indicates which deals are in the process of being resolved. From the user terminal, a “deal in progress” input can be selected by a user at the terminal 18, which is communicated to the appointment board 15 through the dealership server 11. Once a deal is completed, the outcome is presented publically through the appointment board 15. In one embodiment, a completed deal status requires an outcome between the sales personnel and prospect. Thus, through this visual presentation, an environment of positive peer pressure to compete is created furthering the employee's accountability of their marketing efforts. In a further embodiment, the visual name presentation on the appointment board 15 provides positive psychological pressure on the customer to be punctual to their appointment, and on the sales personnel to be punctual in meeting their customer.

A prospective customer may also “virtually” visit a dealership through the world wide web (hereinafter referred to as “Internet Leads”). A prospective customer, from their home terminal 25, may visit a Dealership's website 26 in search of a new or used vehicle. An application hosted in an ASP server 24 and created by an Application Service Provider (ASP) may receive the prospects visit and continue to track their visit through the dealership or OEM website. The ASP application may or may not track the whole history of the prospects visits through methods such as cookies, e-mail addresses, or IP addresses. In an alternative embodiment, the Internet lead management may be conducted through one or more applications stored on at least one terminal 18 and in communication with the dealership server 11 through network 17. In either embodiment, the Dealership/OEM website may be hosted in dealership server 11.

Internet Leads may be generated from at least three website sources: (1) an Original Equipment Manufacturer's (OEM), (2) the Dealership and/or (3) purchased from a third party providing the lead information through tracking technology. The Internet Lead may be “picked up” and stored in an External third party ASP server 24. A message may be routed to the dealership server 11 through network connection 23 and assigned to one or more sales personnel at least one sales terminal 18 automatically or manually. If the Internet Lead is assigned automatically, it may be distributed in a “round robin” or some other organized fashion. The one or more sales personnel may be an employee hired solely to manage Internet Leads (i.e., an “Internet Sales Rep”).

When the message is received by the sales personnel, the message may indicate that one or more new leads have been found and to follow-up on these leads promptly. The message may be transmitted from ASP server 24 to the sales personnel as an e-mail or a pop-up window displayed at terminal 18 once the sales personnel has logged on to their terminal 18. Sales personnel may log on to terminal 18 using a username and password or through fingerprint recognition. Furthermore, the sales personnel may log on to their terminal 18 locally or remotely to access the ASP application housed in ASP server 24 and the Internet Leads. Once the Internet Lead has been assigned to and received by the sales personnel, a follow-up appointment may be made through at least the methods described above. Once the appointment has been made, through the BDC, the sales personnel may store the Internet Lead appointment and generate an entry into the appointment board application to display on to the appointment board 15. Thus, a sales personnel, and the dealership, can make a “virtual” customer into an actual appointment and a potential sale.

In one embodiment, after the Internet Lead has been received and assigned, the user or management may be notified when any Internet Lead has gone unanswered after a pre-determined time has elapsed. The pre-determined time may be based on minutes, hours, or days, or any combination of time. Additionally, the sales personnel may have a variety of tools at their disposal to assist in following up with Internet Leads. For example, the sales personnel may be able to access e-mail templates to quickly and easily contact and respond to Internet Leads or they may have a library of attachments, such as videos or brochures, to include in the communication with the Internet Lead.

The history of a prospect's visit to a dealership may also be tracked. If the ASP application tracks the prospects history of visits to dealership website 26, the prospects visits may be scored to determine how “serious” the customer is about purchasing a vehicle based on a scale such as 1 (being not serious) to 10 (being the most serious). The tracking history may be also used to determine the speed at which a transaction is made between the prospect and the dealership. The scores may be sent as a report to the respective dealerships on a regular basis to provide insight to a dealership manager into which prospect leads are likely the ones to lead to a sale for the dealership. For example, a dealership may be informed through a report the total scores of each visiting customer and an analysis of the scores. In one embodiment, the analysis may include information from public data received from State Motor Vehicle departments. The analysis may include, but may not be limited to, information that indicates how many customers purchased a vehicle from the dealership out of those scored in the application and what the balance of prospects may or may not have done. In this way, a dealership may know the efficacy of their online marketing and the “characteristics” of their purchasing customers. Furthermore, Dealerships can learn how to focus their efforts on those customers which score lower and tend not to purchase from the dealership.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer implemented method for monitoring a sales life cycle of a customer, the method comprising:
capturing primary customer information from a customer identification source (CIS);
inputting secondary customer information;
storing the primary customer information and the secondary customer information to generate a customer profile; and
automatically printing the customer profile wherein the printed customer profile is formatted to serve as a sales document.

2. The method of claim 1 further comprising capturing the primary information by scanning the primary information from the CIS.

3. The method of claim 1 wherein the CIS is a driver's license.

4. The method of claim 1 wherein the CIS is a business card.

5. The method of claim 1 further comprising, prior to receiving the primary and secondary client information, uniquely identifying a user through a log-in or fingerprint recognition.

6. The method of claim 1 wherein the secondary information comprises a co-customer's information, and further comprising capturing the co-customer's information from the co-customer's CIS.

7. The method of claim 1 wherein the printed customer profile is formatted to be customized for a business entity.

8. The method of claim 1 wherein the printed customer profile is used to work a sales proposal or quote.

9. The method of claim 1 further comprising assessing customer traffic information from a plurality of printed customer profile on at least one of a daily, monthly, and yearly basis.

10. A computer implemented method for monitoring a sales life cycle of a customer, the method comprising:
capturing primary customer information from a customer identification source (CIS);
inputting secondary customer information;
storing the primary customer information and the secondary customer information to generate a customer profile;
printing the customer profile wherein the printed customer profile is formatted to serve as a sales document;
communicating a message to the customer at a predetermined time prior to a scheduled follow-up appointment wherein the message serves as a reminder to the customer regarding the scheduled appointment; and
displaying the customer's name on an electronic appointment board, the appointment board indicating the arrival status of the customer.

11. The method of claim 10 further comprising capturing the primary information by scanning the primary information from the CIS.

12. The method of claim 10 wherein the CIS is a driver's license.

13. The method of claim 10 wherein the CIS is a business card.

14. The method of claim 10 further comprising, prior to receiving the primary and secondary client information, uniquely identifying a user through a log-in or fingerprint recognition.

15. The method of claim 10 wherein the secondary information comprises a co-customer's information, and further comprising capturing the co-customer's information from the co-customer's CIS.

16. The method of claim 10 wherein the printed customer profile is formatted to be customized for a business entity and automatically printed.

17. The method of claim 10 wherein the printed customer profile is used to work a sales proposal or quote.

18. The method of claim 10 further comprising assessing customer traffic information from a plurality of printed customer profile on at least one of a daily, monthly, and yearly basis.

19. A system implemented on a computer network for monitoring the sales life cycle of a customer, the system comprising:
a first device in communication with a second device for receiving primary customer information and secondary customer information to generate a customer profile;
at least one third device in communication with the second device for managing customer profiles and communicating a message to the customer at a predetermined time prior to a scheduled follow-up appointment wherein the message serves as a reminder to the customer regarding the scheduled appointment;
a customer identification source (CIS) scanner in communication with the first device for capturing primary customer information;
a printer in communication with the first device and second device for automatically printing the customer profile; and
an electronic appointment board in communication with the first device, the second device, and the third device for displaying a customer name and indicating the arrival status of the customer.

20. The system of claim 19 wherein the first device is substituted for the third device.

21. A program with computer executable instructions embodied in a computer readable medium, the program comprising instructions for:
capturing primary customer information from a customer identification source (CIS);
inputting secondary customer information;
storing the primary customer information and the secondary customer information to generate a customer profile;
automatically printing the customer profile wherein the printed customer profile is formatted to serve as a sales document;
communicating a message to the customer at a predetermined time prior to a scheduled follow-up appointment wherein the message serves as a reminder to the customer regarding the scheduled appointment; and
displaying the customer's name on an electronic appointment board, the appointment board indicating the arrival status of the customer.
